(19) United States
(12) Patent Application Publication
(10) Pub. No.: US 2024/0294371 A1
(43) Pub. Date: Sep. 5, 2024

(54) SADDLE FOR HORSEBACK RIDING

(71) Applicant: PRESTIGE ITALIA S.P.A., Trissino (IT)

(72) Inventor: Giuliano GALLO, Castelfranco Veneto (IT)

(21) Appl. No.: 18/575,088

(22) PCT Filed: May 3, 2022
(86) PCT No.: PCT/EP2022/061829

§ 371 Date: Dec. 28, 2023

(30) Foreign Application Priority Data
Jul. 1, 2021 (IT) 202021000003431

(51) Int. Cl. B68C 1/02

(52) U.S. Cl. CPC B68C 1/02

(57) ABSTRACT

A saddle for horseback riding includes a supporting frame associated with at least one covering body designed to form a sitting region for the user, the supporting frame having a front region, which includes the gullet, and a rear region, which has at least one cantle; the saddle for horseback riding has, laterally to the sitting region, respective flaps and respective skirts which are at least partially superimposed on a respective portion of the flaps; each flap forms, at at least one portion of a region of overlap with the respective skirt, an accommodation hollow for a portion of the respective skirt.

### CROSS-REFERENCE TO RELATED APPLICATIONS

This application is a 35 U.S.C. § 371 National Stage patent application of PCT/EP2022/061829, filed on 3 May 2022, which claims the benefit of Italian patent application 202021000003431, filed on 1 Jul. 2021, the disclosures of which are incorporated herein by reference in their entirety.

### TECHNICAL FIELD

The present disclosure relates to a saddle for horseback riding.

### BACKGROUND

Saddles for horseback riding are normally constituted by a core, saddle tree or supporting frame made of plastic material, composite material, wood or hardened steel, which has the purpose of supporting the rider, and which extends from the gullet, in the front part, to the cantle, in the rear part.

The frame and the parts associated therewith are covered by a covering, which is shaped so as to constitute the so-called seat.

Typically, in addition to the seat, saddles are provided with panels and so-called flaps, often provided with a padding which has the purpose of supporting the rider's knee.

Sometimes, a so-called skirt is superimposed on the actual flap, in contact with the horse, at its upper surface.

Known solutions, despite being widely used, do not always ensure great comfort to the rider, indeed due to the region of overlap between the flap and the lower edge of the skirt.

In order to try to solve this drawback, some solutions have been proposed.

A first known solution provides the flap and the skirt monolithically. However, this produces greater complexity during the production of the saddle.

A second solution provides for starting the flap at the lower edge of the skirt.

However, in this second case, despite being able to increase comfort in use, one obtains, at the lower edge of the skirt, a region in which the relative movement between the lower edge of the skirt and the upper edge of the flap can cause pinching on the thigh of the rider.

### SUMMARY

The aim of the present disclosure is to provide a saddle for horseback riding that is capable of improving the background art in one or more of the aspects indicated above.

Within this aim, the disclosure provides a saddle for horseback riding that is extremely comfortable for the user.

Not least of the disclosure is to provide a saddle for horseback riding that is highly reliable, relatively easy to provide and at competitive costs.

This aim, as well as these and other advantages which will become better apparent hereinafter, are achieved by providing a saddle for horseback riding according to claim 1, optionally provided with one or more of the characteristics of the dependent claims.

### BRIEF DESCRIPTION OF THE DRAWINGS

Further characteristics and advantages of the disclosure will become better apparent from the description of some preferred but not exclusive embodiments of the saddle for horseback riding according to the disclosure, illustrated by way of non-limiting example in the accompanying drawings, wherein:

FIG. 1 is a perspective view of a saddle according to the disclosure in which, for the sake of greater clarity, the skirt has been shown raised with respect to the flap;

FIG. 2 is a perspective view, similar to FIG. 1, with the saddle for horseback riding in the condition for use;

FIG. 3 is a sectional view of the region of overlap between the flap and the skirt of a first embodiment of the saddle for horseback riding according to the disclosure; and

FIG. 4 is a view, similar to FIG. 3, of a second embodiment of the saddle for horseback riding according to the disclosure.

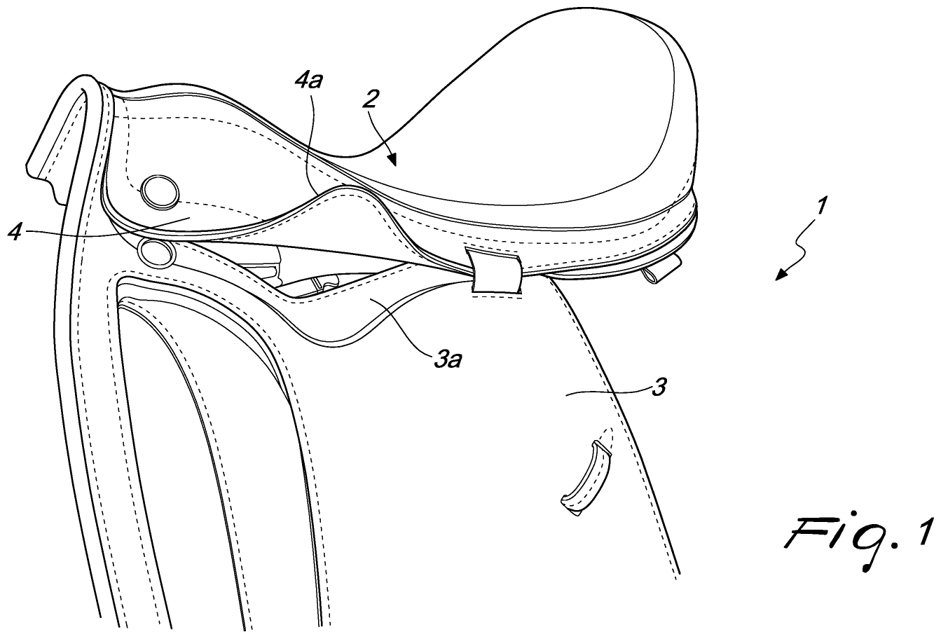

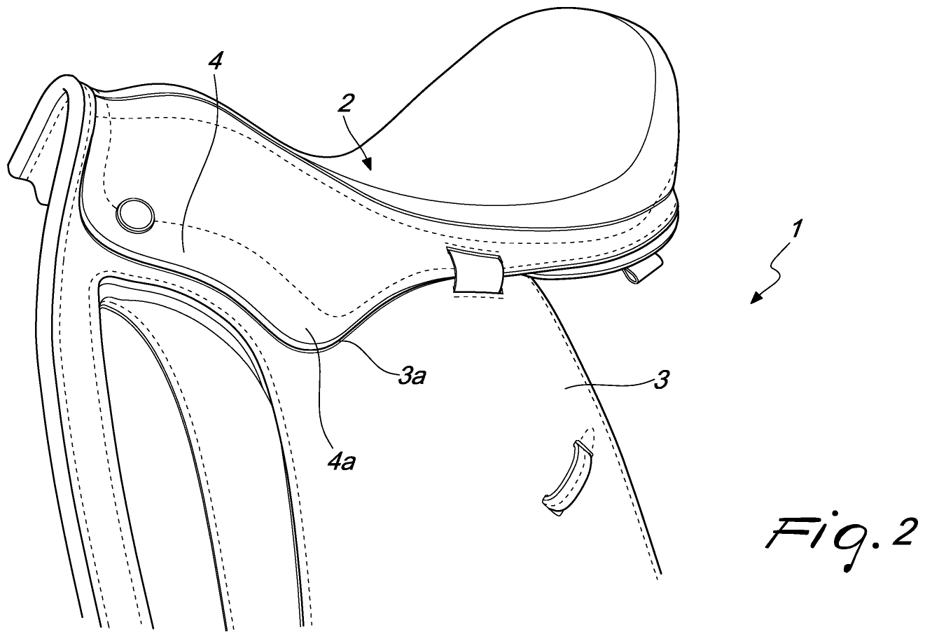

### DETAILED DESCRIPTION OF THE DRAWINGS

With reference to the figures, the saddle for horseback riding according to the disclosure, generally designated by the reference numeral 1, comprises a supporting frame associated with at least one covering body designed to form a sitting region 2 for the user.

The supporting frame has a front region, which comprises the gullet, and a rear region, which comprises at least one rear cantle.

The saddle for horseback riding 1 has, laterally with respect to the seat 2, respective flaps 3 and respective skirts 4 which are at least partially superimposed on a respective portion of the flaps 3.

Each one of the flaps 3 forms, at at least one portion of the region of overlap with the respective skirt 4, an accommodation hollow 3a for a portion of the respective skirt 4.

Conveniently, the accommodation hollow 3a is formed at least at the region that faces the lower edge 4a of the skirt 4.

Conveniently, the outward-facing surface of the saddle for horseback riding 1 formed at the skirt 4 is substantially blended with the outward-facing surface formed at the respective flap 3 and arranged adjacent to the lower edge of the skirt 4.

Advantageously, the flap 3 comprises a leather layer 13 that is directed outward and is coupled, at the region arranged externally with respect to the overlap region, by means of a layer of adhesive 14, to a leather sheet-like element 15.

The leather layer 13 is coupled, at the overlap region, by means of a layer of adhesive 14, to a sheet-like element made of inextensible material 16, which is connected to the upper edge of the leather sheet-like element 15 to form the hollow 3a.

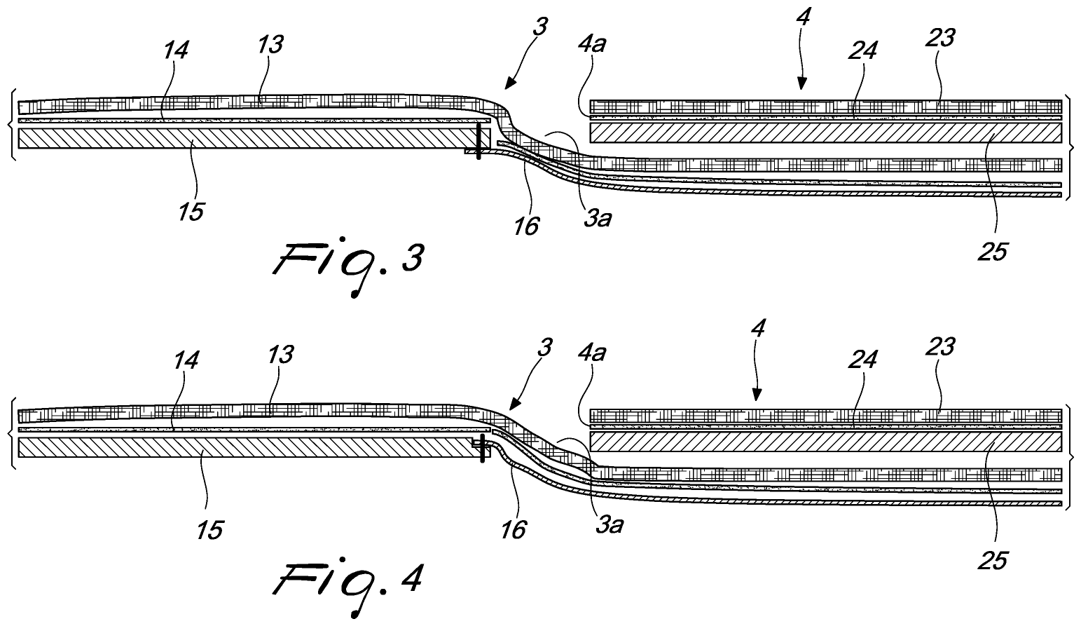

With reference to the embodiment shown in the sectional view of FIG. 3, the sheet-like element made of inextensible material 16 is connected to the upper edge of the leather sheet-like element 15 at its inward-facing surface.

With reference to a further embodiment shown in the sectional view of FIG. 4, the sheet-like element made of inextensible material 16 can be connected to the upper edge of said leather sheet-like element 15 at its outward-facing surface, providing for example a hollow or a step.

The hollow or step can be obtained during the production of the saddle for horseback riding 1, but nothing forbids it from being the result or consequence of the connection between the sheet-like element made of inextensible material 16 and the leather sheet-like element 15.

The skirt comprises a leather layer 23 which is directed outward and is coupled, by means of a layer of adhesive 24, to a leather sheet-like element 25.

In practice it has been found that the disclosure achieves the intended aim and objects, providing a saddle for horseback riding that is extremely comfortable during use.

The disclosure thus conceived is susceptible of numerous modifications and variations, all of which are within the scope of the appended claims. All the details may furthermore be replaced with other technically equivalent elements.

In practice, the materials used, so long as they are compatible with the specific use, as well as the contingent shapes and dimensions, may be any according to the requirements and the state of the art.

1-8. (canceled)

9. A saddle for horseback riding, comprising a supporting frame associated with at least one covering body designed to form a sitting region for a user, said supporting frame having a front region, which comprises a gullet, and a rear region, which comprises at least one rear cantle, said saddle for horseback riding having, laterally to said sitting region, respective flaps and respective skirts which are at least partially superimposed on a respective portion of said flaps, wherein each one of said flaps forms, at at least one portion of a region of overlap with the respective skirt, an accommodation hollow for a portion of the respective skirt.

10. The saddle for horseback riding according to claim 9, wherein said skirt has a lower edge and said accommodation hollow is formed at least at a region that faces a lower edge of said skirt.

11. The saddle for horseback riding according to claim 10, wherein an outward-facing surface of said saddle for horseback riding formed at said skirt is substantially blended with an outward-facing surface formed at the respective flap and arranged in a position that is adjacent to the lower edge of said skirt.

12. The saddle for horseback riding according to claim 9, wherein said flap comprises a leather layer that is directed outward and is coupled, at a region arranged externally with respect to said overlap region, by means of a layer of adhesive, to a leather sheet-like element, said leather layer being coupled, at said overlap region, by means of a layer of adhesive, to a sheet-like element made of inextensible material which is connected to an upper edge of said leather sheet-like element in order to form said accommodation hollow.

13. The saddle for horseback riding according to claim 12, wherein said sheet-like element made of inextensible material is connected to the upper edge of said leather sheet-like element at an inward-facing surface thereof.

14. The saddle for horseback riding according to claim 12, wherein said sheet-like element made of inextensible material is connected to the upper edge of said leather sheet-like element at an outward-facing surface.

15. The saddle for horseback riding according to claim 12, wherein said skirt comprises a leather layer which is directed outward and is coupled, by means of a layer of adhesive, to the leather sheet-like element.

16. The saddle for horseback riding according to claim 12, wherein said sheet-like element made of inextensible material is connected to the upper edge of said leather sheet-like element to provide a hollow or a step.
